(19) United States
(12) Patent Application Publication
(10) Pub. No.: US 2015/0073933 A1
(43) Pub. Date: Mar. 12, 2015

(54) VEHICLE POWERTRAIN SELECTOR

(71) Applicant: Ford Global Technologies, LLC, Dearborn, MI (US)

(72) Inventors: Paul Marshall Stieg, Farmington Hills, MI (US); Michael Cavaretta, Plymouth, MI (US); Michael Alan Tamor, Toledo, OH (US); James Eric Anderson, Dearborn, MI (US); Thomas G. Leone, Ypsilanti, MI (US)

(73) Assignee: Ford Global Technologies, LLC, Dearborn, MI (US)

(21) Appl. No.: 14/023,688

(22) Filed: Sep. 11, 2013

(51) Int. Cl. G06Q 30/06

(52) U.S. Cl. CPC G06Q 30/0631
USPC 705/26.7

(57) ABSTRACT

Vehicle data concerning characteristics of one or more types of vehicle is obtained. Vehicle usage data concerning operation of one or more vehicles is also obtained. A value is predicted for at least one datum for at least one characteristic of the type of vehicle for the user. The at least one datum is used to generate at least one powertrain recommendation for at least one type of vehicle.

BACKGROUND

A given model of a vehicle such as an automobile is generally offered with multiple powertrain options. Different powertrains may require different fuels, offer different fuel efficiencies, perform differently in different environments and/or in response to different driving styles, etc. Further, different consumers may drive on different roads, may drive in different geographic areas with different environmental conditions, and have different driving styles (e.g., drive faster, accelerate more quickly than average), etc. Different consumers may experience different fuel economies with respect to a particular vehicle powertrain, even under similar driving conditions. Unfortunately, mechanisms are lacking for determining what powertrain configuration best suits a particular consumer's driving needs.

### DRAWINGS

FIG. 1 is a block diagram of an exemplary system for generating powertrain recommendations.

FIG. 2 is a diagram of an exemplary process for generating a powertrain recommendation for a particular vehicle operator for a particular type of vehicle.

FIG. 3 is a diagram of an exemplary process including details of generating recommendations for vehicle-powertrain pairs and/or powertrains in a specific make and model of a vehicle using machine learning techniques.

FIG. 4 illustrates an exemplary process including details of generating recommendations for vehicle-powertrain pairs and/or powertrains in a specific make and model of a vehicle using computer simulation techniques.

### DETAILED DESCRIPTION

### Exemplary System Overview

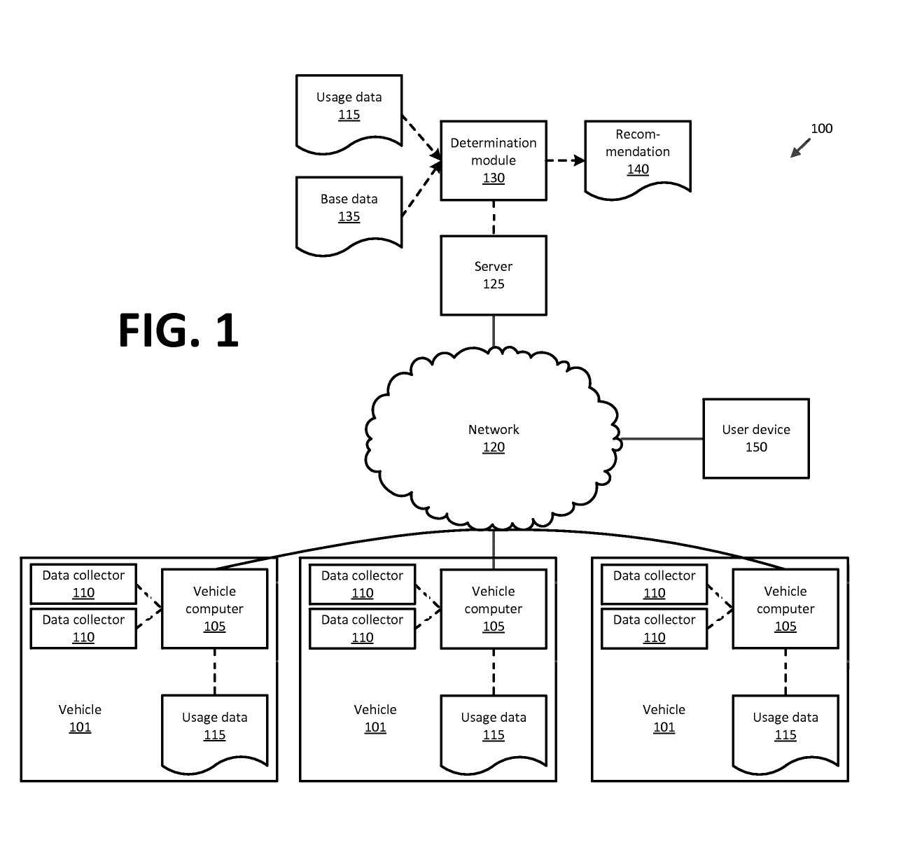

FIG. 1 is a block diagram of an exemplary system 100 for generating powertrain recommendations 140. The system 100 may include one or more vehicles 101, each vehicle 101 including a vehicle computer 105. One or more data collectors 110 in each vehicle 101 provide information to the vehicle computer 105 concerning the various metrics related to operation of the vehicle 101, such information being stored and/or transmitted via a network 120 as usage data 115. In general, the usage data 115 includes information relating to a driver's driving habits that may be relevant to formulating a powertrain recommendation 140. A server 125 receives the usage data 115, generally via the network 120. A determination module 130 included in the server 125 uses the usage data 115 and base data 135 to generate a powertrain recommendation 130. A user device 150 may be used for various purposes, including accessing a powertrain recommendation 140 from the server 125 via the network 120.

### Exemplary System Elements

A vehicle 101 includes a vehicle computer 105 that generally includes a processor and a memory, the memory including one or more forms of computer-readable media, and storing instructions executable by the processor for performing various operations, including as disclosed herein. The memory of the computer 105 further generally stores usage data 115. The computer 105 is generally configured for communications on a controller area network (CAN) bus or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including data collectors 110. Note the computer 105 could include one or more various devices, e.g., an in-vehicle computer, a mobile computer such as a smartphone, etc.

Data collectors 110 may include a variety of devices. For example, various controllers in a vehicle may operate as data collectors 110 to provide data 115 via the CAN bus, e.g., data 115 relating to vehicle speed, acceleration, etc. Further, sensors or the like, global positioning system (GPS) equipment, etc., could be included in a vehicle and configured as data collectors 110 to provide data directly to the computer 105, e.g., via a wired or wireless connection.

Usage data 115 may include a variety of data collected in one or more vehicles based on operations by a particular consumer, i.e., vehicle user. Data 115 is generally collected using one or more data collectors 110, and may additionally include data calculated therefrom in the computer 105, and/or at the server 125. Further, usage data 115 could include data gathered from user input concerning driving habits, e.g., a survey could be presented via an interface of the computer 105 or via some other mechanism (e.g., a website), requesting that a user provide items of data 115. For example, a user could indicate whether and/or how often the user tows trailers (and a typical trailer weight), carries items on roof racks (and what types of items), drives off-road, uses the vehicle for racing, takes long trips, and/or other types of vehicle 101 usage that might not be captured during a limited time of data acquisition. Likewise, usage data 115 concerning a user or group of users could be provided via other sources, e.g., data from a customer relationship management (CRM) database, data concerning fleet operations, etc.

In general, usage data 115 may include any data that may be gathered and/or computed, and that may be relevant to vehicle powertrain usage. For example, usage data 115 may include vehicle speed, vehicle 101 acceleration, percent of time at idle, average trip duration, average distance driven per trip, ambient outside temperature, geographic locations and time spent thereat, fuel consumption data, etc.

As seen in FIG. 1, system 100 may include a plurality of vehicles 101, although it should be understood that the systems and methods disclosed herein regarding generating predictions with respect to vehicle powertrains may operate for one vehicle 101 or a fleet of vehicles 101.

The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks, local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various of the steps and processes described herein. Such instructions include instructions in various modules such as a determination module 130 that includes simulators, and/or machine learning techniques, e.g., neural network classifiers, to generate powertrain recommendations 140.

Base data 135 includes various sets of data, each set of base data 135 including operating parameters and/or default performance characteristics of a particular powertrain configuration of a particular model of vehicle 101. For example, base data 135 may include default performance characteristics such as fuel economy estimates for a particular powertrain configuration calculated according to one or more predefined metrics, e.g., fuel economy estimates calculated according to rules promulgated by the United States Environmental Protection Agency at 40 C.F.R. §600.114-08. Further, base data 135 may include operating parameters of a powertrain, such as acceleration curve showing how quickly a vehicle 101 with the powertrain accelerates from zero to various speeds over time, engine size, transmission configuration (number of speeds, automatic/manual), etc. Further, base data 135 may include parameters associated with the particular model of vehicle 101, such as curb weight, aerodynamic drag coefficient, tire rolling resistance, etc., as well as effects on these parameters resulting from added accessories (trailer, roof rack, etc.) or loads (cargo weight, etc.).

In general, a powertrain recommendation 140 may be generated according to a deterministic simulation and/or a statistical prediction of likely powertrain usage based on usage data 115 and base data 135. The determination module 130 may operate by employing predictive modeling techniques, e.g., training one or more neural networks and/or other machine learning techniques that accept collected data 115 as input, and provide as output weighting factors that may be applied to base data 135 for various powertrains in generating recommendations 140. Alternatively or additionally, a simulator included in the determination module 130 may use selected collected data 115 and/or selected base data 135 as input, e.g., data specifying factors such as those listed in more detail below, but possibly including an average vehicle speed, distance driven, commuting time, annualized vehicle usage, environmental conditions such as ambient temperature, usage of a climate control system, weather conditions, etc., to run a simulation generating predictions of a powertrain performance with respect to various characteristics, e.g., fuel economy.

In general, a recommendation 140 may include a recommendation for a powertrain configuration of a particular make or model of a vehicle, and/or what may be referred to as a vehicle-powertrain pair, i.e., a recommendation 140 for a particular make and model of a vehicle employing a specific powertrain configuration available for the particular vehicle make and model. A powertrain recommended for a vehicle may include virtually any available powertrain, e.g., a powertrain could include an internal combustion (IC) engine, a manual transmission, an automatic transmission, a hybrid electric powertrain, a plug-in hybrid electric powertrain, a pure electric powertrain, engines using different fuels (gasoline, ethanol blends, diesel, CNG, LPG, etc.), engines using “start-stop” technology, etc. The general objective of a recommendation 140 is to provide a driver (or group of drivers for a vehicle 101 fleet) with advice concerning a powertrain or vehicle-powertrain pair that will provide a likely suitable driving experience (e.g., desired fuel economy, desired acceleration characteristics, desired towing or off-road capability, etc.).

A user device 150 may be any one of a variety of computing devices including a processor and a memory, as well as communication capabilities. For example, the user device 155 may be a portable computer, tablet computer, a smart phone, etc. that includes capabilities for wireless communications using IEEE 802.11, Bluetooth, and/or cellular or other communications protocols. Further, the user device 155 may use such communications capabilities to communicate via the network 120 and also directly with a vehicle computer 105 and/or data collectors 110, e.g., using a CAN bus, OBD-II, Bluetooth, and/or other wired or wireless mechanisms.

### Exemplary Process Flows

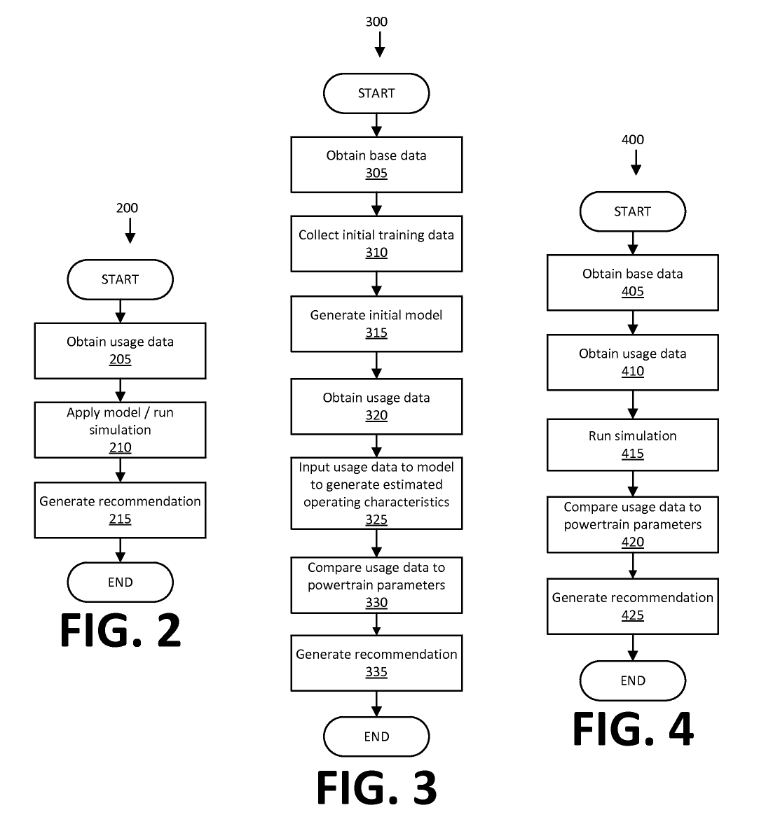

FIG. 2 is a diagram of an exemplary process 200 for generating a powertrain recommendation 140 for a particular vehicle operator for a particular type of vehicle 101, or for a group of operators using a fleet of vehicles 101. For example, the process 200 may be carried out by the server 125 according to instructions included in the determination module 130.

The process 200 may begin in a block 205, in which the server 125 obtains usage data 115 related to a particular vehicle user, or, as in the case where a recommendation 140 is being obtained for a fleet of vehicles 101, the data 115 may be related to a plurality of vehicle users; in any event, the data 115 may be obtained from one or more vehicle computers 105 and/or user devices 150. Usage data 115 is generally provided in conjunction with an identifier for a vehicle 101 from which the usage data 115 was provided, and also generally with an identifier for an operator of the vehicle 101. Base data 135 is also generally associated with an identifier for a vehicle 101. Note that identifying a vehicle 101 generally includes, in addition to identifying a make and model of the vehicle 101, further identifying a specific type of vehicle 101, i.e., a trim level including a specific powertrain configuration of the vehicle 101. Further, in some implementations, a user may specify particular vehicles 101 and/or vehicle-powertrain pairs (explained further below) for which the user would like recommendations 140, e.g., “show me which powertrain among Fusions is best,” meaning that only base data 135 relating to Ford Fusions is used, or “compare gasoline Fusion to a gasoline Focus,” meaning that only base data 135 for those two vehicle-powertrain pairs is considered.

Next, in a block 210, the server 125 inputs the usage data 115 and the base data 135 to determination module 130, e.g., to a simulation, a machine classifier such as a neural network, etc. Exemplary operations of the determination module 130 are discussed in further detail below with respect to FIGS. 3 and 4.

Next, in a block 215, the determination module 130 outputs a powertrain recommendation 140. The server 125 may provide the recommendation 140 to a user via a variety of mechanisms, e.g., via a printed report, webpage, email, short message service (SMS) text message, etc. In general, the recommendation 140 may identify a specific powertrain of a vehicle 101 recommended for a user, i.e., a consumer whose usage data 115 has been input to the module 130, and/or can include a predicted fuel economy for the user for one or more powertrains. Further, as mentioned above, a recommendation 140 may include a recommendation for what may be referred to as a vehicle-powertrain pair, i.e., a recommendation 140 for a particular make and model of a vehicle employing a specific powertrain configuration available for the particular vehicle make and model.

Following the block 215, the process 200 ends.

FIG. 3 illustrates an exemplary process flow 300 including additional details of operations of the determination module 130 for generating recommendations 140 for vehicle-powertrain pairs and/or powertrains in a specific make and model of a vehicle 101 using machine learning techniques.

The process 300 begins in a block 305, in which the server 125 obtains base data 135 for the vehicle 101 type or types being considered. For example, fuel economy information included in base data 135 for a vehicle 101 type is generally publicly available and/or maintained by a vehicle 101 manufacturer. Publicly available fuel economy data may include regulatory sources such as EPA data, and consumer sources such as Consumer Reports, automotive review magazines, etc. Further, a vehicle 101 manufacturer or publicly available source may maintain base data 135 relating to vehicle 101 acceleration characteristics, engine size, transmission configuration (number of speeds, automatic/manual), fuel type, degree of hybridization, etc.

Next, in a block 310, the server 125 obtains training data related to operations of the vehicle 101. For example, a vehicle 101 manufacturer or other party may operate the vehicle 101 in a test environment, in a road test, etc., to obtain initial usage data 115 for use as the initial set of training data. Further, in subsequent iterations of the process 300, usage data 115 may be provided as training data in the block 310.

Next, in a block 315, the server 125 creates an initial model, e.g., using a set of neural networks, for generating recommendations 140 using the training data obtained in the block 310. (It should be understood that, for purposes of the process 300, “creating” a model could refer to training and modifying an existing model, and does not necessarily refer to creating a totally new model.) Recommendations 140 are generally based on estimates of one or more operating characteristics of a vehicle 101. An example of an operating characteristic of a vehicle 101 is fuel economy, although other examples are possible, such as factors affecting vehicle acceleration such as engine size, vehicle weight, etc. Further, fuel economies may be calculated or obtained in a variety of ways. Further, multiple models may be created in the block 315, e.g., one for each vehicle-powertrain configuration that may be considered in the process 300.

For example, a model could include a set of neural networks configured to generate a probability that operation of the vehicle 101 would approximate known fuel economy standards, e.g., the so-called “five-cycle” fuel economy labels promulgated by the United States Environmental Protection Agency. These estimates of fuel economy include the “city” driving estimated by federal test procedure (FTP) FTP-75 and the “highway” driving estimated by the Highway Fuel Economy Test (HWFET). In addition, the US EPA estimates generally include the so-called Supplemental Federal Test Procedure (SFTP) tests SFTP US06 (high-speed, moderate ambient temperature, no air-conditioning), SFTP SC03 (air-conditioning test at 95° Fahrenheit), and a cold FTP test that is generally the same as the city cycle, except performed at an ambient temperature of 20° Fahrenheit.

As mentioned above, 40 C.F.R. §600.113-08 provides “Fuel economy calculations for FTP, HWFET, US06, SC03 and cold temperature FTP tests.” Accordingly, each of the five EPA estimates may be represented by a respective set of one or more equations, as is known. Creating a model in the block 315 may include training a neural network for each of the five estimates for a type of vehicle 101 to provide a probability or weighting factor for each of the respective fuel economy estimates. Possible weighting factors are discussed below with respect to the block 325.

Next, in a block 320, the server 125 obtains usage data 115 from one or more users' operation of one or more vehicles 101, e.g., transmitted from a computer 105 and/or user device 150 via the network 120. Mechanisms by which the computer 105 and/or user device 150 may gather usage data 115 are discussed above.

Next, in a block 325, the server 125 inputs the usage data 115 into the model(s) created as described with respect to the block 315, and generates one or more predicted operating characteristics for operation of respective vehicle-powertrain pair or a powertrain. For example, the predicted operating characteristics could include re-calculating weighting factors applied to each of five fuel economy test cycles for the vehicle 101, thereby predicting an overall fuel economy for a specific user of a type of vehicle 101, e.g., for a specific powertrain. For example, weighting factors could be calculated based on:
calculation of average trip lengths in usage data 115, followed by a calculation of “start” penalties, i.e., taking into account that shorter trips have poorer fuel economy than longer trips due to the poorer efficiency of “cold” powertrains;
calculation of maximum or near-maximum trip lengths in usage data 115, e.g. 95th percentile or 99th percentile trip lengths (this factor is particularly important in evaluating the feasibility of powertrains and/or vehicles that use alternate fuels, based on fuel availability in the customer's area, and/or, in the case of electric vehicles, battery size);
calculation of typical time spent at idle in usage data 115;
trip frequency in usage data 115, e.g., time between trips;
proximity to refueling/recharging stations during trips in usage data 115;
calculation of “running” fuel economy at 75° Fahrenheit based on specific power for a vehicle 101 type (e.g., based on velocity, acceleration, road loads, and mass);
Adjustment for ambient temperatures in usage data 115, e.g., where ambient temperatures are cold, i.e., below a certain threshold; note that ambient climate data may be inferred based on a geographic location;
Adjustment for HVAC (heating, ventilation, and air-conditioning) usage, especially air-conditioning; note that annual-average HVAC usage can be inferred based on climate data in a geographic location, optionally modified with limited observation of the customer's HVAC usage; further, note that HVAC usage has a strong effect on fuel economy for hybrid-electric (HEV) and stop-start vehicles, and on driving range for electric vehicles (EVs).;
adjustment for non-dyno effects, e.g., plus or minus 10% for factors such as hills, wind, precipitation, rough roads, etc.;
typical frequency and duration of various vehicle speeds in usage data 115;
typical frequency, duration, and rates of acceleration in usage data 115;
typical on-vehicle passenger and cargo weight;
whether towing a trailer (and, if so, weight and road load of trailer);
whether carrying items on the roof (and, if so, added road load due to aerodynamic drag);
snow plow usage;
altitude;
terrain (amount of hill climbing);
off-road usage;
whether a user's typical driving area is one where alternate fuel (e.g., ethanol, diesel, CNG, LPG, electric vehicle charging station) is readily available.

Next, in a block 330, the server 125 may compare powertrain parameters for the vehicle 101 included in base data 135 with parameters provided from usage data 115 for the type of vehicle 101, or some other type of vehicle 101 that is similar. Further, the server 125 may evaluate vehicle-powertrain pairs to be included in a recommendation 140, in which case base data 135 for more than one vehicle 101 may be considered. In any event, a driver may have certain driving habits, e.g., a “lead foot” or the like such that the driver regularly accelerates to a high-speed in a small amount of time. Base data 135 may indicate that the particular vehicle 101 powertrain will not support such acceleration habits. Similarly, usage data 115 may indicate that the driver frequently tows heavy trailers, and again, base data 135 may indicate that the particular vehicle 101 powertrain will not support towing heavy loads. Based on the block 330, vehicles 101 having certain powertrain configurations may be excluded from possible inclusion in a recommendation 140.

Next, in a block 335, the server 125, e.g., the determination module 130, uses the predicted operating characteristic(s) determined as described above, and generally also the comparison of the block 330, to generate one or more powertrain, or vehicle-powertrain, recommendations 140. For example, the determination module 130 may be configured to generate a recommendation 140 for a vehicle 101 having a powertrain that will provide a driver with the best possible fuel economy. However, other considerations may be taken into account. For example, as mentioned above, vehicles 101 having powertrains that are physically incompatible with a driver's usage data 115 may be excluded. Similarly, driving habits may be taken into account; for example, a user with a penchant for rapid acceleration might receive a recommendation 140 for a powertrain including a largest available engine. Further for example, based on driving habits, fuel economy predictions, and/or powertrain characteristics, a total cost of vehicle ownership, e.g., on a monthly, annual, etc., basis, could be predicted and provided.

Following the block 335, the process 300 ends.

FIG. 4 illustrates an exemplary process flow 400 including additional details of operations of the determination module 130 for generating recommendations for vehicle-powertrain pairs and/or powertrains in a specific make and model of a vehicle 101 using computer simulation techniques.

The process 400 begins in a block 405, in which, similar to the block 305 discussed above, the server 125 obtains base data 135 for the vehicle 101 type or types being considered.

Next, in a block 410, in a manner similar to that discussed above concerning the block 320, the server 125 obtains usage data 115 from one or more users' operation of one or more vehicles 101.

Next, in a block 415, the server 125 uses base data 135 and usage data 115 to run one or more computer simulations to determine likely fuel economies, for various vehicle-powertrain pairs and/or powertrain configurations for a specific vehicle. For example, a simulator such as Simulink® from MathWorks of Natick, Mass., U.S.A., may be used. The simulator may be configured to use vehicle 101 properties such as vehicle weight, road load, coastdown coefficients, aerodynamic drag coefficient, frontal area, etc. to calculate power required to drive the vehicle at each time step or data point of usage data 135. The power calculation may be performed for the complete set of usage data 135, or for a statistically representative subset of usage data 135. The simulator may further be configured to calculate fuel consumed as a function of power required and other factors including engine speed, transmission gear and/or torque converter lockup state, hybrid powertrain state, etc. Such fuel consumption calculations may be based on data or models for various powertrains available for vehicle 101. The simulator may further be configured to sum up or integrate total fuel consumed during usage data 135 (or a subset thereof), including fuel required for idle, cold start or trip length penalties, etc. The simulator may further be configured to calculate an average fuel economy for various powertrains or vehicle-powertrain pairs based on usage data 135, or to calculate statistical ranges of expected fuel economy, e.g. an average and standard deviation.

Next, in a block 420, in a manner similar to that discussed above concerning the block 330, the server 125 may compare powertrain parameters for the vehicle 101 included in base data 135 with parameters provided from usage data 115 for the type of vehicle 101. Further, the server 125 may evaluate vehicle-powertrain pairs to be included in a recommendation 140, in which case, as mentioned above, base data 135 for more than one vehicle 101 may be considered and/or base data 135 for specific vehicle-powertrain pairs may be considered.

Next, in a block 420, in a manner similar to that discussed above concerning the block 335, the server 125, e.g., the determination module 130, uses the predicted operating characteristic(s) determined as described above, and generally also the comparison of the block 330, to generate one or more powertrain, or vehicle-powertrain, recommendations 140.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer server that includes a processor and a memory, wherein the server is configured to:
obtain vehicle data concerning characteristics of one or more types of vehicle;
obtain vehicle usage data concerning operation of one or more vehicles;
predict a value for at least one datum for at least one characteristic of the type of vehicle for the user; and
use the at least one datum to generate at least one powertrain recommendation for at least one type of vehicle.

2. The system of claim 1, wherein the at least one datum is a fuel economy prediction.

3. The system of claim 1, wherein the at least one datum is a cost of ownership.

4. The system of claim 1, wherein the vehicle characteristics data includes at least one of an acceleration curve for a vehicle, engine size, transmission configuration, fuel type, and degree of hybridization.

5. The system of claim 1, wherein the value is predicted using one of a machine learning algorithm and a computer simulation.

6. The system of claim 5, wherein the usage data includes at least one of an average trip length, an average trip frequency, a geographic location, an average proximity to refueling stations, fuel consumption data, an ambient outside temperature, heating, ventilation, and air-conditioning usage, an adjustment for non-dyno effects, vehicle speed, vehicle acceleration, typical on-vehicle passenger and cargo weight, whether an item is towed, snow plow usage, altitude, terrain, off-road usage, a vehicle percent of time at idle, and whether a user's typical driving area is one where alternate fuel is available.

7. The system of claim 1, wherein the usage data pertains to at least one of a plurality of vehicles and a plurality of vehicle users.

8. A method, comprising:
obtaining vehicle data concerning characteristics of one or more types of vehicle;
obtaining vehicle usage data concerning operation of one or more vehicles;
predicting a value for at least one datum for at least one characteristic of the type of vehicle for the user; and
using the at least one datum to generate at least one powertrain recommendation for at least one type of vehicle.

9. The method of claim 8, wherein the at least one datum is a fuel economy prediction.

10. The method of claim 8, wherein the at least one datum is a cost of ownership.

11. The method of claim 8, wherein the vehicle characteristics data includes at least one of an acceleration curve for a vehicle, engine size, transmission configuration, fuel type, and degree of hybridization.

12. The method of claim 8, wherein the value is predicted using one of a machine learning algorithm and a computer simulation.

13. The method of claim 12, wherein the usage data includes at least one of an average trip length, an average trip frequency, a geographic location, an average proximity to refueling stations, fuel consumption data, an ambient outside temperature, heating, ventilation, and air-conditioning usage, an adjustment for non-dyno effects, vehicle speed, vehicle acceleration, typical on-vehicle passenger and cargo weight, whether an item is towed, snow plow usage, altitude, terrain, off-road usage, a vehicle percent of time at idle, and whether a user's typical driving area is one where alternate fuel is available.

14. The method of claim 8, wherein the usage data pertains to at least one of a plurality of vehicles and a plurality of vehicle users.

15. A non-transitory computer-readable medium tangibly embodying computer-executable instructions thereon, the instructions comprising instructions to:
obtain vehicle data concerning characteristics of one or more types of vehicle;
obtain vehicle usage data concerning operation of one or more vehicles;
predict a value for at least one datum for at least one characteristic of the type of vehicle for the user; and
use the sat least one datum to generate at least one powertrain recommendation for at least one type of vehicle.

16. The medium of claim 15, wherein the at least one datum is a fuel economy prediction.

17. The medium of claim 15, wherein the at least one datum is a cost of ownership.

18. The medium of claim 15, wherein the vehicle characteristics data includes at least one of an acceleration curve for a vehicle, engine size, transmission configuration, fuel type, and degree of hybridization.

19. The medium of claim 15, wherein the value is predicted using one of a machine learning algorithm and a computer simulation.

20. The medium of claim 19, wherein the usage data includes at least one of an average trip length, an average trip frequency, a geographic location, an average proximity to refueling stations, fuel consumption data, an ambient outside temperature, heating, ventilation, and air-conditioning usage, an adjustment for non-dyno effects, vehicle speed, vehicle acceleration, whether an item is towed, snow plow usage, altitude, terrain, off-road usage, a vehicle percent of time at idle, and whether a user's typical driving area is one where alternate fuel is available.

21. The medium of claim 15, wherein the usage data pertains to at least one of a plurality of vehicles and a plurality of vehicle users.
